(19) United States
(12) Patent Application Publication
(10) Pub. No.: US 2004/0189817 A1
(43) Pub. Date: Sep. 30, 2004

(54) Electronic equipment system and time correction method

(75) Inventor: Makoto Akiba, Saitama-shi (JP)

Correspondence Address: LEYDIG VOIT & MAYER, LTD, 700 THIRTEENTH ST. NW, SUITE 300, WASHINGTON, DC, 20005-3960, US

(73) Assignee: Fuji Photo Optical Co., Ltd., Saitama-shi (JP)

(21) Appl. No.: 10/809,388

(22) Filed: Mar. 26, 2004

(30) Foreign Application Priority Data
Mar. 28, 2003 (JP) 2003-091098

(51) Int. Cl. G06F 11/00

(52) U.S. Cl. 348/211.2

(57) ABSTRACT

A camera system (electronic equipment system) includes a remote controller for transmitting a remote control signal containing a time data signal, and a camera for receiving the remote control signal to correct time information. The camera includes a remote control signal receiving circuit for receiving the remote control signal, a display for displaying and blinking for a predetermined time period represented by the time data signal contained in the remote control signal received by the remote control signal receiving circuit, and a correction unit for correcting time information based on the time data signal contained in the remote control signal received by the receiving circuit.

### BACKGROUND OF THE INVENTION

1. Field of the Invention

The present invention relates to an electronic equipment system correcting the time of electronic equipment based on a remote control signal, and a time correction method thereof.

2. Related Background Art

There has been disclosed in the Patent Document 1 and the like an electronic equipment system in which time information of the electronic equipment is corrected based on a signal from external equipment.

According to the function of adjusting the time of a clock by the remote controller described in the Patent Document 1, time data of the clock contained in the remote controller is transmitted to equipments such as a home video recorder, wherein the home video recorder which has received the time data adjusts the time of its clock based on the received time data. After the adjustment of the time of the clock has been completed, the display of the time is blinked.

[Patent Document 1]

Japanese Unexamined Patent Publication (Tokukai) Number H06-121376.

### SUMMARY OF THE INVENTION

However, in the invention described above, the time being displayed and blinked is updated after a predetermined time has-elapsed, and some users therefore occasionally felt unpleasant or uncomfortable. The present invention aims to provide an electronic equipment system and time correction method which solve the above problems.

An electronic equipment system according to the present invention comprises a remote controller for transmitting a remote control signal containing a time data signal, and electronic equipment for receiving the remote control signal to correct time information, the electronic equipment comprising a receiving means for receiving the remote control signal, a displaying and blinking means for displaying and blinking, for a predetermined period, the time represented by the time data signal contained in the remote control signal received by the receiving means, and a correction means for correcting time information based on the time data signal contained in the remote control signal received by the receiving means.

In the electronic equipment system, the displaying and blinking means displays and blinks the time represented by the time data signal contained in the remote control signal received by the receiving means, whereupon hence the time being displayed and blinked is not updated even if the predetermined time has elapsed. Therefore the user does not feel uncomfortable.

In the electronic equipment system, the correction means may measure a time which has elapsed since the reception of the remote control signal, and may correct time information based on the time obtained by adding the time which has elapsed since the reception of the remote control signal to the time represented by the time data, after the displaying and blinking means has finished displaying and blinking process.

When the time is corrected after the displaying and blinking having been finished, an actual time is calculated by adding the time which has elapsed since the reception of the remote control signal to the time represented by the time data, whereby the time is corrected precisely based on the time data received from the remote controller.

In the electronic equipment system, the electronic equipment may further comprise a key, button, or switch for executing a predetermined process, and the displaying and blinking means may finish displaying and blinking process, when said key, button, or switch is pressed.

When the key, button, or switch of the electronic equipment is pressed while the corrected time is being displayed and blinked, a predetermined process can be started immediately by causing the displaying and blinking means to finish the displaying and blinking even if a predetermined time has not elapsed.

In the electronic equipment system, the electronic equipment preferably may be a camera.

A time correction method according to the present invention is a time correction method for correcting the time of electronic equipment based on a remote control signal transmitted from a remote controller, comprising the steps as follows: remote control signal transmitting step wherein a remote control signal containing a time data signal is transmitted from the remote controller to the electronic equipment, and a displaying and blinking step wherein the display means of the electronic equipment displays and blinks, for a predetermined period, the time represented by the time data signal contained in the remote control signal, and a correction step wherein time information is corrected based on the time data signal contained in the remote control signal received in the receiving step.

In the displaying and blinking step of the time correction method, the time represented by the time data contained in a remote control signal received in the receiving step is displayed and blinked, whereupon hence the time being displayed and blinked is not updated even if the predetermined time has elapsed. Therefore the user does not feel unpleasant or uncomfortable.

In the correction step of the above mentioned time correction method, as a characteristic feature thereof a time which has elapsed since the reception of the remote control signal may be measured, and time information may be corrected based on the time obtained by adding the time which has elapsed since the reception of the remote control signal to the time represented by the time data, after the display means has finished displaying and blinking process in the course of the displaying and blinking step.

When the time is corrected after the displaying and blinking having been finished, an actual time is calculated by adding the time which has elapsed since the reception of the remote control signal to the time represented by the time data, whereby the time is corrected precisely based on the time data received from the remote controller.

In the displaying and blinking step of the time correction method, the display means may finish displaying and blinking process when the key, button, or switch of the electronic equipment for executing a predetermined process is pressed.

When the key, button, or switch of the electronic equipment is pressed while the corrected time being displayed and blinked, a predetermined process can be started immediately by causing the displaying and blinking means to finish the displaying and blinking even if a predetermined time has not elapsed.

In the time correction method, the electronic equipment is preferably a camera.

### BRIEF DESCRIPTION OF THE DRAWINGS

FIG. 1 shows a perspective view showing a camera system according to the embodiment.

FIG. 2 shows a block diagram showing the configuration of the remote controller shown in FIG. 1.

FIG. 3 shows an outline view showing a partial configuration of the remote controller shown in FIG. 1.

FIGS. 4A-4C show figures showing an example of the display of a date and time on the LCD shown in FIG. 3: FIG. 4A shows an example of the full display; FIG. 4B shows an example of the display of date; and FIG. 4C shows an example of the display of time.

FIGS. 5A and 5B show figures depicting a remote control signal transmitted from the remote controller: FIG. 5A shows a release signal; and FIG. 5B shows a date signal.

FIG. 6 shows a block diagram showing the configuration of the camera shown in FIG. 1.

FIG. 7 shows an outline showing a partial configuration of the camera shown in FIG. 1.

FIG. 8 shows a figure showing an example of full display on the LCD shown in FIG. 7.

FIG. 9 shows a flowchart showing the SM open process of the camera shown in FIG. l.

FIG. 10A shows an example manner in which the time of the camera is displayed and blinked, and FIG. 10B shows a flowchart showing the process flow of the camera.

### DESCRIPTION OF THE PREFERRED EMBODIMENTS

With reference to accompanying drawings there will be made a description of a preferred embodiment of the present invention below. Dimensions shown in the figures and described dimensions are not drawn to scale. In the drawings, the same reference numerals or symbols denote the same or corresponding elements. Repetitive description is omitted.

In the embodiment, there will be made a description of a camera system as an exemplary embodiment of an electronic equipment system.

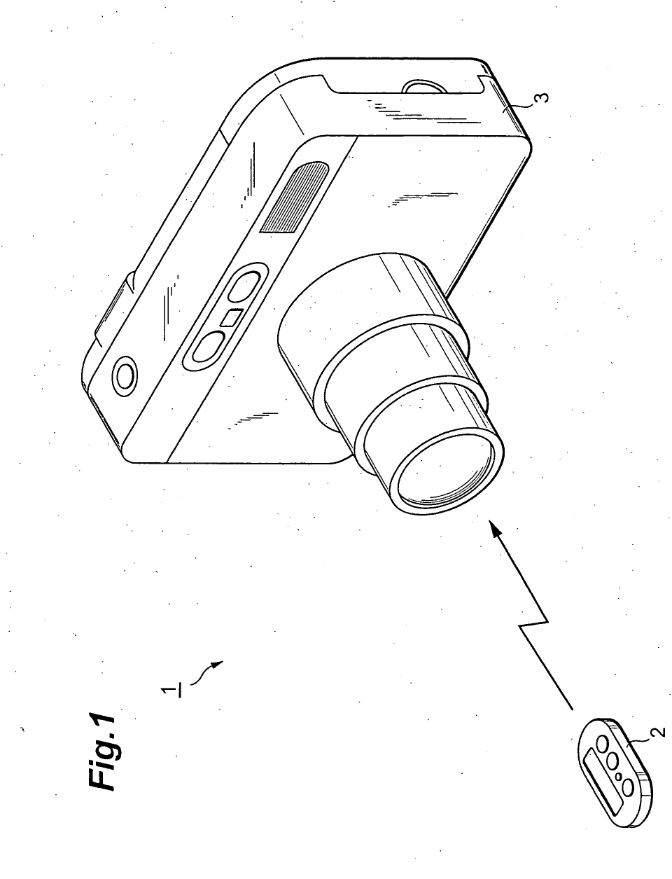

FIG. 1 is a perspective view showing the configuration of a camera system according to the embodiment. As shown in FIG. 1, the camera system 1 according to the embodiment comprises a remote controller 2 and the main unit (called camera hereinafter) 3, and is able to transmit a predetermined signal to the camera 3 by operating the remote controller 2.

The remote controller 2 is an external equipment capable of transmitting a remote control signal to the camera 3. The camera 3 has a photographing function and a receiving function of receiving a signal transmitted from the remote controller 2. When the camera 3 is set to a mode in which it is operated by the remote controller 2, it is made possible to receive a remote control signal transmitted from the remote controller 2, and performs a predetermined process based on the remote control signal. In the camera system 1 according to the embodiment, the remote control operation mode includes a first mode in which zoom and release operations are performed, a second mode in which time information of the camera is corrected, and a third mode in which the operations are performed and the time information is corrected. These modes can be switched over by operations. The “remote control signal” described above is a data signal, a command signal, or the like, more specifically, a command signal (operation signal) such as a release signal allowing the camera to perform a release operation, or a time data signal (date signal) having information related to date and time.

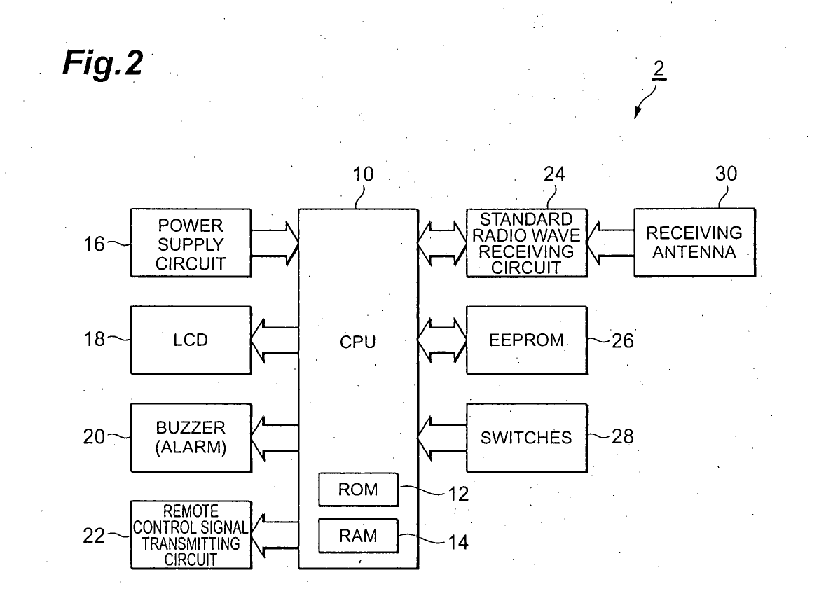

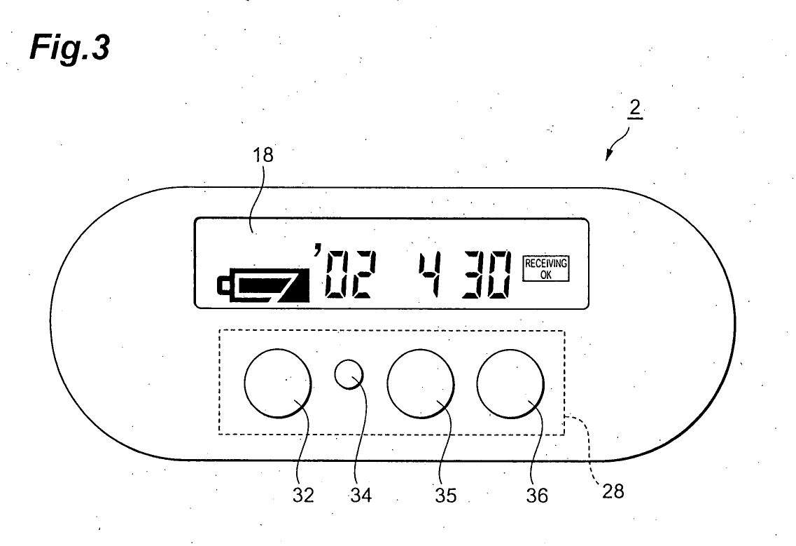

Next, the remote controller 2 will be explained in detail with reference to FIGS. 2 and 3. FIG. 2 is a block diagram showing the configuration of the remote controller 2 shown in FIG. 1, and FIG. 3 is an outline view showing a partial configuration of the remote controller 2 shown in FIG. 1.

As shown in FIG. 2, the remote controller 2 has a CPU 10 for controlling the whole of the remote controller 2. The CPU 10 contains a ROM 12 in which programs for control and computation processes are stored in advance, and a RAM 14 for storing various data at the time of control or computation. The CPU 10 has a clock function of counting up seconds, minutes, hours, days, months, and years based on a reference clock.

The CPU 10 is connected to a power supply circuit 16, a LCD 18, a buzzer (alarm) 20, a remote control signal transmitting circuit 22, a standard radio wave receiving circuit 24, an EEPROM 26, and switches 28. The power supply circuit 16 supplies the power from a battery or the like to the CPU 10. The LCD 18 displays the quantity of electricity stored in the battery or the like, and a date and time counted by the CPU 10. The LCD 18 also displays whether the standard radio wave has been normally received.

The buzzer 20 makes a notification sound indicating that a remote control signal is transmitted when it is transmitted, and a notification sound indicating whether the standard radio wave has been normally received. The remote control signal transmitting circuit 22 transmits a remote control signal to the camera 3, using infrared rays, for example. The standard radio wave receiving circuit 24 receives the standard radio wave. The standard radio wave receiving circuit 24 is connected with a receiving antenna 30. The receiving antenna 30 receives the standard radio wave, and is constituted, for example, in such a way that a lead wire is wound around a ferrite core. When the remote controller 2 receives the standard radio wave, it corrects a date and time counted by the CPU 10 to obtain the ones based on the standard radio wave. Thus, the remote controller 2 is able to display the information about a correct date and time.

The EEPROM 26 stores a state of the remote controller at every point of time, various kinds of control parameters, and the like. The switches 28 include, as shown in FIG. 3, a date switch 32, a setting switch 34, a date signal transmitting switch 35, and a release signal transmitting switch 36.

The date switch 32 is used for changing the format of a date and time displayed on the LCD 18, for example, from “year-month-day” to “day-hour-minute”. The date switch also has a function of changing the order to be corrected during the date-and-time correction mode, for example, from “year” to “month” or from “month” to “day”.

The setting switch 34 is used for correcting a date and time displayed on the LCD 18, wherein for example, there are counted up years, months, and days during the date-and-time correction mode. By operating this switch 34, the display of year, for example, can be changed from “01” to “02”. The date signal transmitting switch 35 is used for transmitting a date signal about date and time. The release signal transmitting switch 36 is used for transmitting a release signal allowing the camera 3 to perform a release operation.

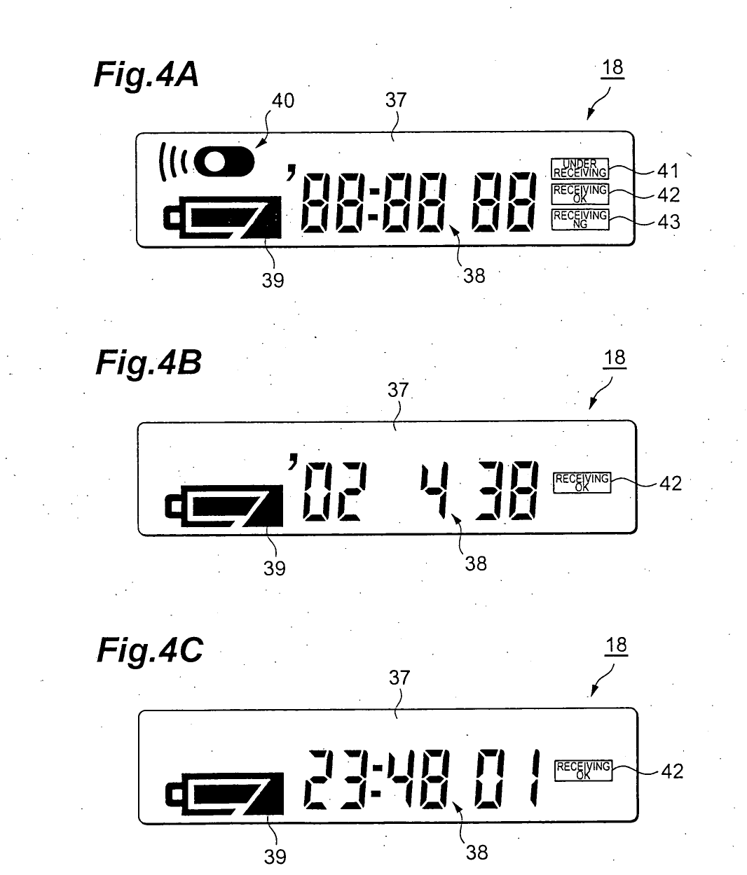

Examples of the display of a date and time displayed on the LCD 18 when the date switch 32 is operated are described below. FIGS. 4A-4C show examples of the display of a date and time on the LCD 18 shown in FIG. 3. FIG. 4A shows an example of full display, FIG. 4B shows an example of the display of a date, and FIG. 4C shows an example of the display of a time.

As shown in FIG. 4A, the LCD 18 has a display area 37 providing a date and time display 38 related to a year, month, day, hour, minute, and second, a battery mark display 39 showing the quantity of electricity stored in the battery, and a transmission display 40 showing that a remote control signal containing a release signal and date signal has been transmitted. The display area 37 also provides an under-receiving display 41, a normal-receiving display, and an abnormal-receiving display. For example, the under-receiving display 41 is comprised of the characters “UNDER RECEIVING”, the normal-receiving display 42 consists of the characters “RECEIVING OK”, and the abnormal-receiving display 43 consists of the characters “RECEIVING NG”. The under-receiving display 41, the normal-receiving display 42, and the abnormal-receiving display 43 are not limited to the above characters, but may be symbols such as antenna mark, etc.

By operating the date switch 32, the display on the LCD 18 is changed over, for example, from FIG. 4B to FIG. 4C, or from FIG. 4C to FIG. 4B. In the display area 37 shown in FIG. 4B, a “year-month-day” is displayed as the date and time display 38. In the display area 37 shown in FIG. 4C, an “hour-minute-second” is displayed as the date and time display 38. That is, the user of the remote controller 2 may operate the date switch 32 to select a desired display state. In FIGS. 4(b) and (c), the battery mark display 39 and the normal-receiving display 42 are also provided.

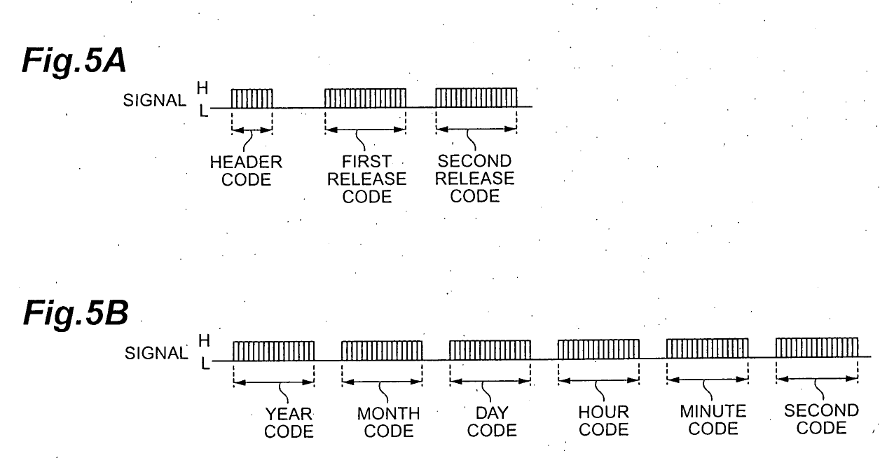

Next, a remote control signal transmitted from the remote controller 2 will be explained with reference to FIGS. 5A and 5B. The remote control signal consists of a command signal and a subsequent time data signal. FIGS. 5A and 5B depict a remote control signal transmitted from the remote controller 2. FIG. 5A shows an example of the remote control signal in which a release signal is transmitted as a command signal. FIG. 5B shows an example of date signal transmitted subsequently to the release signal. More specific description is provided below.

At first, the release signal will be explained with reference to FIG. 5A. The release signal contains a header code at the head of it. The camera 3 is able to recognize the head of the received signal by detecting the header code. The release signal also contains a first release code following the header code. The release signal also contains a second release code following the first release code. The second release code is identical with the first release code. When the camera 3 has received the first release code or the second release code, it performs a release operation.

Such being the case, the release signal consists of the header code, the first release code, and the second release code. The reason why the two release codes are contained is that even if the camera has failed to receive the first release code, it can receives the second release code to perform a release operation.

Next, the date signal will be explained with reference to FIG. 5B. The date signal contains a year code, a month code, a day code, an hour code, a minute code, and a second code in this order. These codes contain the information representing a year, month, day, hour, minute, and second respectively. The date signal is recognized as such because of being transmitted subsequently to the first release signal and the second release signal.

As such, the date signal consists of a year code, a month code, a day code, an hour code, a minute code, and a second code. The date signal depends on a date and time counted by the CPU 10, and if the remote controller 2 receives the standard radio wave and corrects a date and time counted by the CPU 10, the information about the date and time contained in the date signal to be transmitted, that is, the information contained in the codes becomes to be based on the standard radio wave.

The operation signal contained in the remote control signal transmitted from the remote controller 2 is not limited to the release signal, and may be a signal other than the release signal, such as a zoom signal or power on/off signal.

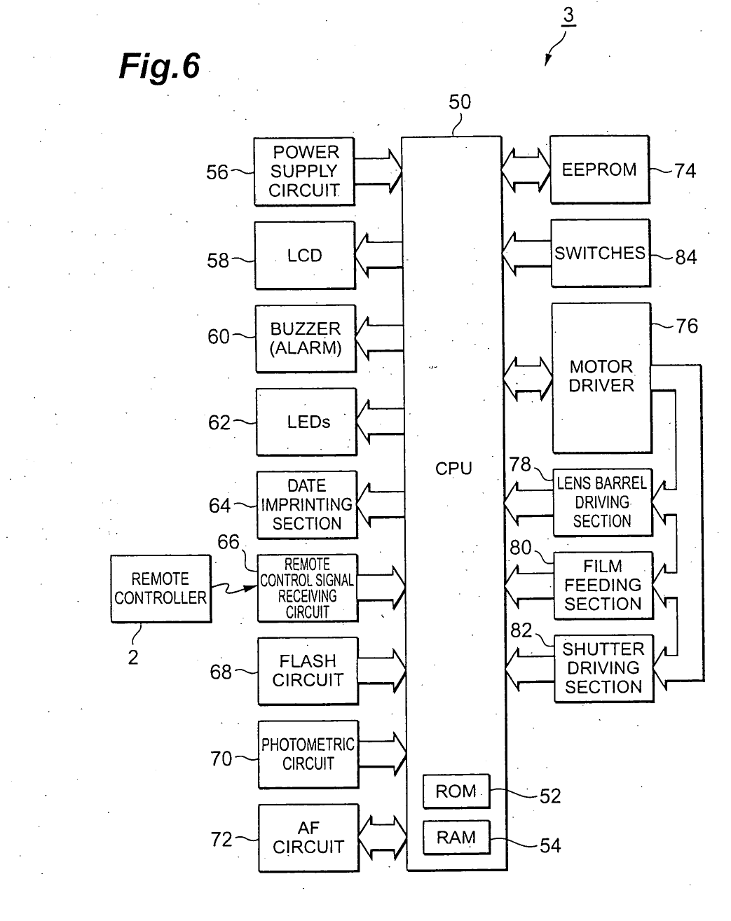

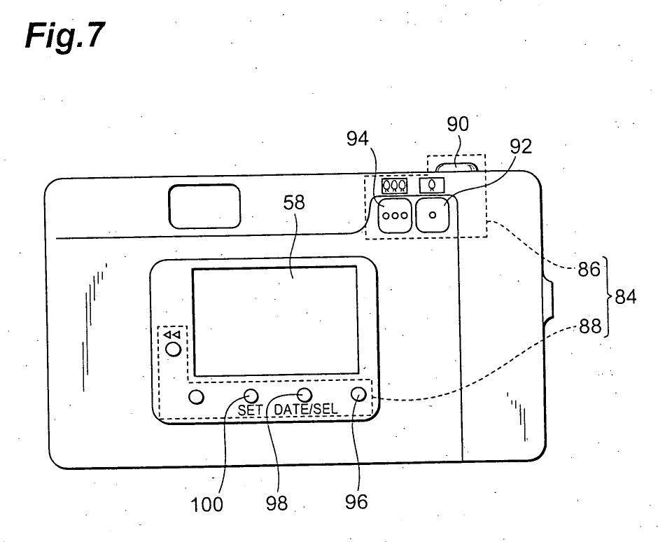

Next, the camera 3 will be in more details with reference to FIGS. 6 and 7. FIG. 6 is a block diagram showing the electrical configuration of the camera 3 shown in FIG. 1, and FIG. 7 is an outline view showing a partial configuration of the camera 3 shown in FIG. 1. FIG. 7 shows the back of the camera 3.

As shown in FIG. 6, the camera 3 has a CPU 50 including a ROM 52 and a RAM 54. The CPU 50 contains a ROM 52 in which programs for control and computation processes are stored in advance, and a RAM 54 for storing various data at the time of control or computation. The CPU 50 has a clock function of counting up seconds, minutes, hours, days, months, and years based on a reference clock. The function of the “determining means” stated in claims is realized in such a manner that the CPU 50 reads the program stored in the ROM 52 to execute it. The CPU 50 is connected with a power supply circuit 56, a LCD 58, a buzzer 60, LEDs 62, a date imprinting section 64, a remote control signal receiving circuit 66, a flash circuit 68, a photometric circuit 70, an AF circuit 72, an EEPROM 74, a motor driver 76, a lens barrel driving section 78, a film feeding section 80, a shutter driving section 82, and switches 84. The power supply circuit 56, the LCD 58, the buzzer (alarm) 60, and the EEPRO 74 are similar to those of the remote controller 2.

The LEDs 62 include a LED for auto-focus, a LED for self-mode, and the like, and indicate the states of the camera 3 by turn-on, turn-off, etc. The date imprinting section 64 imprints a date and time when a photographing is performed, and the like on a film. The remote control signal receiving circuit 66 receives a remote control signal from the remote controller 2 and has function as a receiving means.

The flash circuit 68 contains a light-emitting element provided in the flash window, and causes the light-emitting element to flash according to a selected mode (a mode associated with a light-emitting manner of the flash and the like) under the control of the CPU 50.

The photometric circuit 70 detects the brightness of the light incident through the photographic lens from a subject to decide an F-number and a shutter speed when the automatic exposure function is selected. The AF circuit 72 is a distance measuring circuit for automatic focus control, and contains, for example, a light-emitting element and a light-receiving element in the AF light-transmitting window and the light-receiving window respectively. The AF circuit 72 measures the distance to a subject, using the light-emitting element and light-receiving element, based on the principle of triangulation distance measurement, according to the instruction from the CPU 50, and outputs the result of the measurement to the CPU 50.

The motor driver 76 receives a control signal from the CPU 50 to output driving signals to the lens barrel driving section 78, the film feeding section 80, and the shutter driving section 82. When receiving the driving signal, the lens barrel driving section 78 expands or collapses the lens barrel, the film feeding section 80 feeds the film of the film cartridge charged in the camera, in the forward direction or the backward direction, and the shutter driving section 82 drives the shutter.

The switches 84 includes, as shown in FIG. 7, photographic switches 86 and setting switches 88. The photographic switches 86 include switches such as a release switch 90, TELE switch 92, and WIDE switch 94 associated with photography. The release switch 90 allows the camera to perform a release operation. A photographer can take a photograph by operating this switch. The TELE switch 92 and the WIDE switch 94 are used for zooming. A photographer can take a photograph of a subject as is the case where the photographer is near the subject by operating the TELE switch 2, and can take a photograph of a subject as is the case where the photographer is away from the subject by operating the WIDE switch 94.

The setting switches 88 include a power switch 96, a date switch 98, and a setting switch 100. The power switch 96 is used for switching between the supply and the shut-off of power from the power supply circuit 56 to the CPU 50. The date switch 98 has a function similar to that of the remote controller 2, and a function as a switching section for switching dates and times imprinted by the date imprinting section 64. The setting switch 100 is similar to that of the remote controller 2.

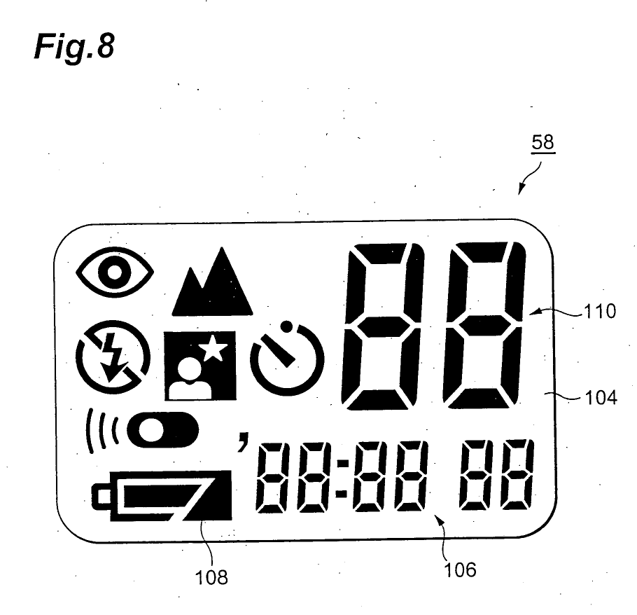

Next, displays on the LCD 58 of the camera 3 will be explained with reference to FIG. 8, which shows an example of full display on the LCD 58 shown in FIG. 7. The LCD 58 has a display area 104 providing a date and time display 106 related to a year, month, day, hour, and minute, a battery mark display 108 showing the quantity of electricity stored in the battery, a film frame number display 110 showing the number of unexposed frames or the number of exposed frames of a film, and the like.

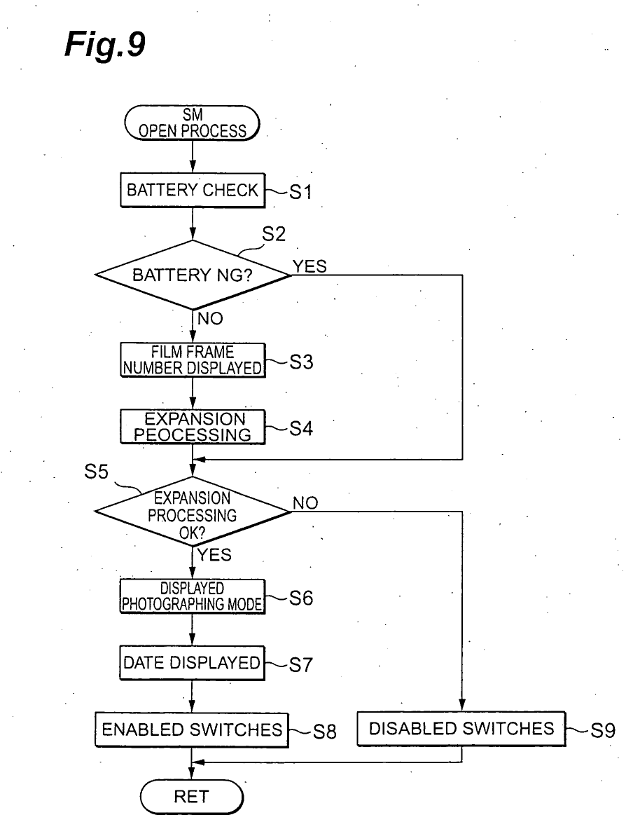

Next, the SM open process of the camera 3 will be explained with reference to FIG. 9. The SM open process is a process of expanding the lens barrel from the camera, and the like to enable the camera to take a photograph.

FIG. 9 is a flowchart showing the SM open process of the camera shown in FIG. 1. The SM open process is performed in such a case that the power switch 96 is operated to turn on the power supply circuit 56 in a state that the power to the CPU 50 is shut off by the power supply circuit 56, and then power is supplied to the CPU 50.

At first, battery check is performed in step S1. The battery check is a processing of checking the voltage of the battery of the camera 3. After the check, the process goes to step S2. In step S2, it is determined whether the voltage of the battery is a NG value. When it is determined that the voltage of the battery is a NG value, the process goes to step S5. On the other hand, when it is determined that the voltage of the battery is not a NG value, the process goes to step S3.

In step S3, the number of frames of the film is displayed. Here, the number of frames of the film is displayed as a numerical value in the film frame number display area 110. Then, the process goes to step S4, where the expansion processing is performed. In this processing, the lens barrel driving section 78 which has received a driving signal from the motor driver 76 expands the lens barrel. Then, the process goes to step S5.

In step S5, it is determined whether the expansion processing is OK. That is, it is determined whether the lens barrel has been normally expanded. This determination is made, for example, depending on whether the lens barrel has been expanded to a preset WIDE position. When it is determined that the expansion processing is OK, the process goes to step S6, where a photographing mode is displayed. This display is a display of a mode associated with a light-emitting manner of the flash, or the like. Along with this display, it is not displayed whether the displayed mode is the date correction mode or the photographic mode.

Then, the process goes to step S7, where a date and time is displayed. In this step, a date and time is displayed as numerical values in the date and time display area 106 of the LCD 58 of the camera 3. After that, the process goes to step S8, where the switches 90 to 100 are enabled. Then, a series of processing are finished.

On the other hand, when it is determined in step S5 that the expansion processing is not OK, the process goes to step S9, where the switches 90 to 100 are disabled. Then, a series of processing are finished. Each of the switches 90 to 100 is enabled or disabled by switching between the IN port and OUT port corresponding to the switch.

When the SM open process is normally finished, the switches 90 to 100 are enabled. Thus, the operation and the like of the camera 3 are made possible by the switches.

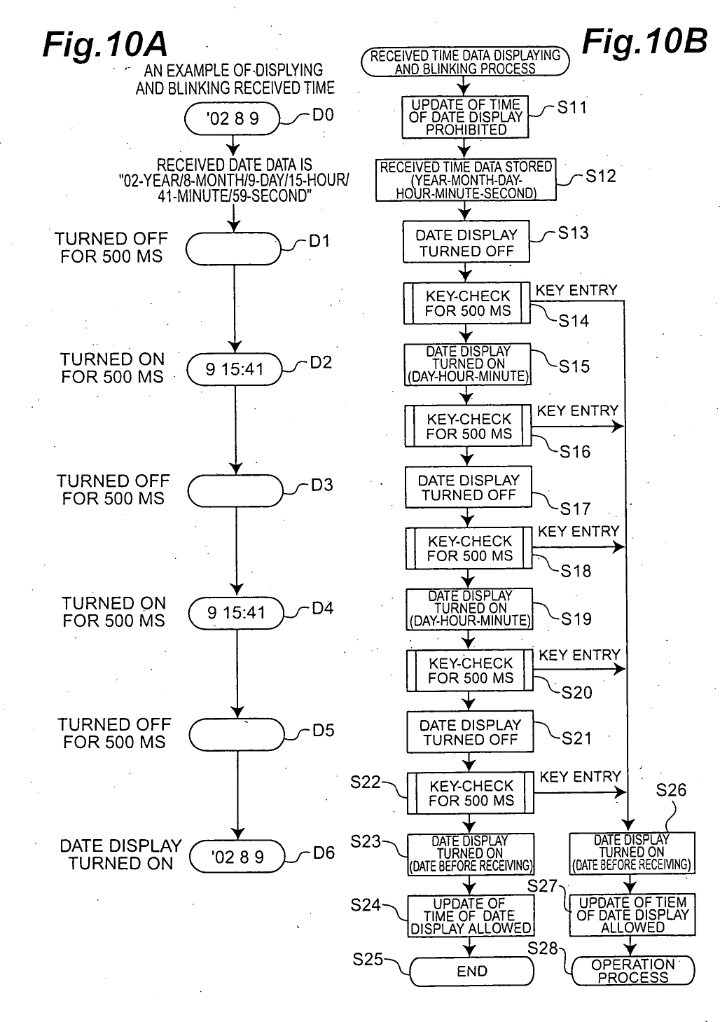

Next, the operation of the camera 3 based on the remote control signal transmitted from the remote controller 2 will be described with reference to FIGS. 10A and 10B. FIG. 10A shows an example manner in which the time of the camera 3 is displayed and blinked, and FIG. 10B is a flowchart showing the process flow of the camera 3.

When a remote control signal contained a date signal is transmitted from the remote controller 2, and the camera 3 receives the remote control signal, the camera 3 starts the process of displaying and blinking the received time data. At the time when the remote control signal is received, time information is displayed on the LCD 58 in the “year-month-day” format as shown in the display D0 in FIG. 10A. When the remote control signal is received, there is inhibited at first updating the date display in step S11. In the following flow, operations of the camera 3 such as making a judgment and deciding or controlling respective step leading to such a transition of resultant states are achieved or effected in such a manner that the CPU 50 reads programs previously stored in the ROM 52 and executes computation and control based on the programs.

Next, in step S12, the received time data is set in the time data RAM of the camera 3. Here, it is assumed that the received time data is “02-year/8-month/9-day/15-hour/41-minute/59-second”. Then, in step S13, the date display is turned off as shown in the display D1 in FIG. 10A. Then, in step S14, key entry check is performed for 500 ms. When there has been made key entry, the date display is turned on, in step S26, to indicate the date before the remote control signal is received in the “year-month-day” format, and then, in step S27, it is allowed to update the time in the date display and the time is corrected based on the received date signal. There after, in step s28 there is carried out processing for operations based on key entry made. When there has been made no key entry in step S14, the date display is turned on, in step S15, to indicate the date in the “day-hour-minute” format as shown in the display D2 in FIG. 10A. That is, “9 15:41” is indicated. In this step, the date display indicates the time information relying on the date signal included in the received remote control signal. Next, key entry check is performed for 500 ms in step S16. When there has been made key entry, the date display is turned on, in step S26, to indicate the date before the remote control signal is received in the “year-month-day” format, and then, in step S27, it is allowed to update the time in the date display and the time is corrected based on the received date signal. When there has been made no key entry in step S16, the date display is turned off as shown in the display D3 in FIG. 10A in step S17. The processing in this step is similar to that at the time of turning off the date display in step S13. Next, in step S18, key entry is awaited for 500 ms, and when there has been made no key entry, the date display is turned on, in step S19, to indicate the date in the “day-hour-minute” format as shown in the display D4 in FIG. 10A. That is, “9 15:41” is indicated. The processing in this step is similar to that at the time of turning on the date display in step S15. Next, in step S20, key entry is awaited for 500 ms, and when there has been made no key entry, the date display is turned off as shown in the display D5 in FIG. 10A in step S21. The processing in this step is similar to that at the time of turning off the date display in step S13. Next, in step S22, key entry is awaited for 500 ms.

When there has been made no key entry in step S22, the date display is turned on, in step S23, to indicate the date before the remote control signal is received in the “year-month-day” format, and then, in step S24, it is allowed to update the time in the date display and the time is corrected based on the received date signal. After that, the time correction process of the camera 3 is finished (step S25).

In the camera system 1 and the time correction method of the camera system 1 according to this embodiment, the camera 3 displays and blinks the time represented by the time data signal included in the received remote control signal, and whereupon hence the time being displayed and blinked is not updated even if the predetermined time-has elapsed. Therefore the user does not feel unpleasant or uncomfortable. More specifically, in the above example, when the date display is turned on at the second time (step S19), 1.5 seconds has passed since the remote control signal was received. In this case, in a conventional device, the time is updated and indicated as shown in “9 15:42”, and some users therefore may feel unpleasant or uncomfortable. However, according to this embodiment, the time data included in the remote control signal is displayed and blinked, and no user therefore feels unpleasant or uncomfortable.

According to the present invention, the displaying and blinking means displays and blinks the time represented by the time data contained in a remote control signal received by the receiving means, and whereupon hence no time being displayed and blinked is updated even if the predetermined time has elapsed. Therefore no user feels unpleasant or uncomfortable.

1. An electronic equipment system comprising:
a remote controller for transmitting a remote control signal containing a time data signal; and
electronic equipment for receiving the remote control signal to correct time information, said electronic equipment comprising:
receiving means for receiving the remote control signal;
displaying means for executing a blinking display, for a predetermined period of time represented by the time data signal; and
correction means for correcting time information based on the time data signal.

2. The electronic equipment system according to claim 1, wherein said correction means measures a time which has elapsed since reception of the remote control signal, and corrects time information based on a time obtained by adding the time which has elapsed since reception of the remote control signal to the time represented by the time data signal, after said displaying means has finished the blinking display.

3. The electronic equipment system according to claim 1, wherein said electronic equipment further comprises one of a key, a button, and a switch for executing a predetermined process, and said displaying means finishes the blinking display when said key, button, or switch is actuated.

4. The electronic equipment system according to claim 2, wherein said electronic equipment further comprises one of a key, a button, and a switch for executing a predetermined process, and said displaying means finishes the blinking display when said key, button, or switch is actuated.

5. The electronic equipment system according to claim 1, wherein said electronic equipment is a camera.

6. A time correction method for correcting time maintained by an electronic equipment, based on a remote control signal transmitted from a remote controller, the method comprising:
transmitting a remote control signal containing a time data signal from said remote controller to said electronic equipment,
displaying a blinking display, for a predetermined period of time represented by the time data signal, and
correcting time information based on the time data signal.

7. The time correction method according to claim 6, including, in correcting the time information, measuring a time which has elapsed since reception of the remote control signal, and correcting the time information based on a time obtained by adding the time which has elapsed since the reception of the remote control signal to the time represented by the time data signal, after displaying of the blinking display has finished.

8. The time correction method according to claim 6, including finishing the blinking display when one of a key, a button, and a switch of said electronic equipment actuated.

9. The time correction method according to claim 7, including finishing the blinking display when one of a key, a button, and a switch of said electronic equipment actuated.

10. The time correction method according to claim 6, wherein said electronic equipment is a camera.
